(19) United States
(12) Patent Application Publication
(10) Pub. No.: US 2010/0164912 A1
(43) Pub. Date: Jul. 1, 2010

(54) INFORMATION CODE READING APPARATUS AND READING METHOD

(75) Inventors: Yusuke Soga, Tsurugashima-shi, Saitama (JP); Manabu Nohara, Saitama (JP); Takayuki Akimoto, Saitama (JP); Tomoaki Iwai, Saitama (JP); Ryoji Noguchi, Saitama (JP)

Correspondence Address: DRINKER BIDDLE & REATH (DC), 1500 K STREET, N.W., SUITE 1100, WASHINGTON, DC, 20005-1209, US

(73) Assignee: Pioneer Corporation, Tokyo (JP)

(21) Appl. No.: 12/294,687

(22) PCT Filed: Mar. 27, 2007
(86) PCT No.: PCT/JP2007/056374

§ 371 Date: Oct. 16, 2008

(30) Foreign Application Priority Data
Mar. 27, 2006 (JP) 2006-084375

(51) Int. Cl. G09G 5/00; G09G 3/28

(52) U.S. Cl. 345/204; 345/60

(57) ABSTRACT

An object of the present invention is to provide a method and device for reading an information code in which an information code displayed on a display can be read without increasing the circuit size of the display device. To read the information code displayed on the display in a predetermined area during each frame display interval, a synchronization signal synchronized with each of the frame display intervals is generated based on noise emitted from the display, and the information code is restored from a captured image signal obtained by capturing a screen of the display as an image in accordance with the synchronization signal.

### TECHNICAL FIELD

The present invention relates to a device for reading an information code that is used to read an information code displayed on a display.

### BACKGROUND ART

Display devices (e.g., see Patent Document 1) have been proposed in recent years in which coordinate information representing a coordinate position on a display is superimposed and displayed in a primary image based on an input image signal, and the coordinate information is read by a pen-type input indicator, whereby the coordinate position on the display indicated by the pen-type input indicator can be acquired. In such a display device, driving based on a subfield group for displaying the primary image, and driving based on a subfield group for displaying the coordinate information, are sequentially carried out during one-field display interval designed to superimpose and display the coordinate information in the primary image. The display device is configured so that a synchronization signal that is synchronized with the execution interval of the subfield group for displaying the coordinate information is supplied to the pen-type input indicator in order to allow the pen-type indicator to read only the coordinate information.

Therefore, the device had a problem that a circuit is required in the display device in order to transmit the synchronization signal to the pen-type input indicator, and the size of the device is increased.

Patent Document 1: Japanese Patent Kokai No. 08-115057

### DISCLOSURE OF THE INVENTION

### Problems to be Solved by the Invention

An object of the present invention is to provide a method and device for reading an information code displayed on a display in which the information code can be read without increasing the circuit size of the display device.

### Means Used to Solve the Problems

In the device for reading an information code according to the present invention, an information code displayed on a display is read in a predetermined area during each frame display interval, the device for reading an information code having noise detection means for detecting noise emitted from the display; synchronization detection means for generating a synchronization signal synchronized with the frame display interval on the basis of the noise; and means for restoring the information code from a captured image signal obtained by capturing a display screen of the display as an image in accordance with the synchronization signal.

In the method for reading an information code according to the present invention, an information code displayed on a display is read in a predetermined area during each frame display interval, the method for reading an information code having a noise detection step for detecting noise emitted from the display; a synchronization detection step for generating a synchronization signal synchronized with the frame display interval on the basis of the noise; and a step for restoring the information code from a captured image signal obtained by capturing a display screen of the display as an image in accordance with the synchronization signal.

### EFFECT OF THE INVENTION

A synchronization signal synchronized with the frame display interval of a display device is self-generated in a reading device, eliminating the need to provide the display device with a circuit for transmitting the synchronization signal to the reading device.

### BRIEF DESCRIPTION OF THE DRAWINGS

FIG. 1 is a diagram showing a schematic configuration of an electronic blackboard provided with an electronic chalk based on the present invention;

FIG. 2 is a diagram showing a portion of an array of pixel cells P and pixel blocks PB in the PDP 100 shown in FIG. 1;

FIG. 3 is a diagram showing an example of a light emission drive sequence when the PDP 100 is driven;

FIG. 4 is a diagram showing a light emission pattern when the primary image display drive stage (subfields SF1 to SF8) is executed in accordance with the light emission drive sequence shown in FIG. 3;

FIG. 5 is a diagram showing an example of the blackboard image displayed by the PDP 100;

FIG. 6 is a diagram showing the internal configuration of the electronic chalk 9 according to the present invention;

FIG. 7 is a diagram showing an example of the internal configuration of the frame synchronization detection circuit 93 shown in FIG. 6; and

FIG. 8 is a diagram showing an example of the noise Mode in the PDP in which a noise NZP is generated in the blanking interval BT.

### EXPLANATION OF SIGNS

9 Electronic chalk
91 Image sensor
92 Noise sensor
93 Frame synchronization detection circuit
100 Plasma display panel

### BEST MODE FOR CARRYING OUT THE INVENTION

To read an information code displayed on a display in a predetermined area during each frame display interval, a synchronization signal synchronized with each of the frame display intervals is generated based on noise emitted from the display, and the information code is restored from a captured image signal obtained by capturing a screen of the display as an image in accordance with the synchronization signal. In this case, each of the frame display intervals in a plasma display panel is composed of a blanking interval and an interval in which display driving is carried out by a plurality of subfields. Therefore, when an area is detected in which the noise is interrupted during the same interval length as the blanking interval, or in cases in which the noise initially generated after being interrupted continues only briefly, the synchronization signal is generated with the timing of the initially generated noise.

### Embodiment 1

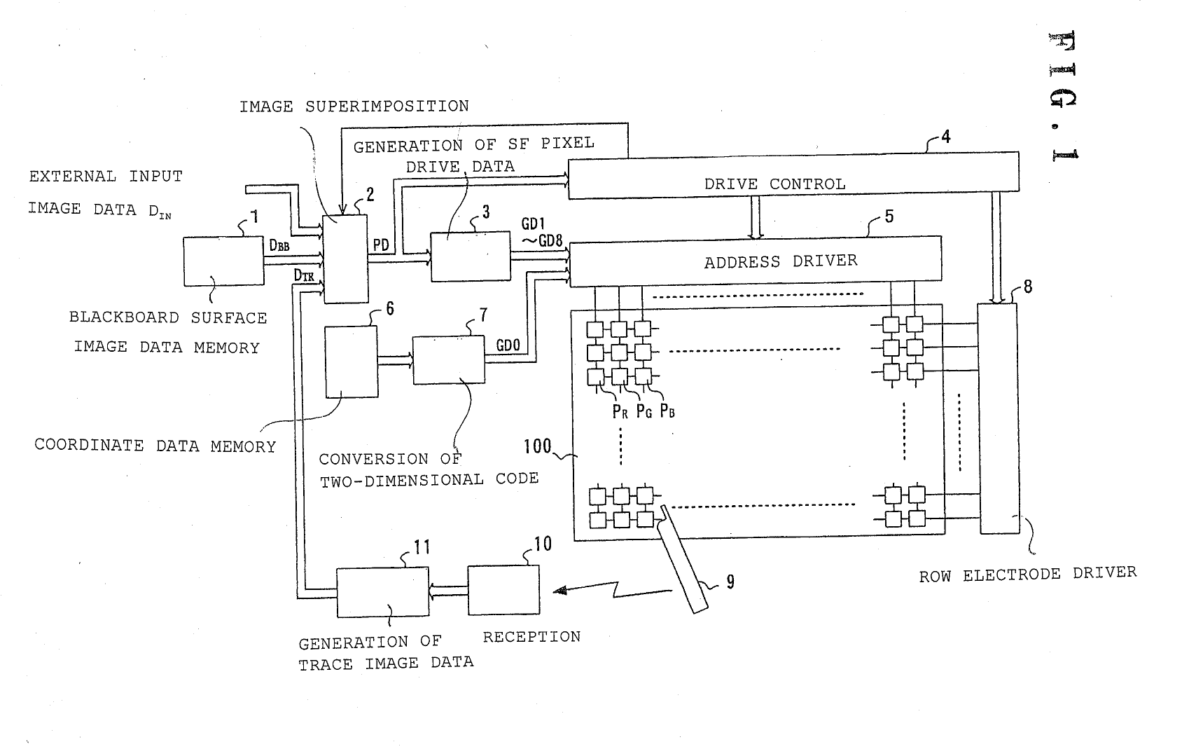

FIG. 1 is a diagram showing the configuration of an electronic blackboard provided with an electronic chalk as the device for reading an information code according to the present invention.

In FIG. 1, a plasma display panel 100 (hereinafter referred to as PDP 100) as an electronic blackboard unit is provided with a transparent front surface substrate (not shown) for carrying the blackboard surface, and a back surface substrate (not shown). A discharge space in which a discharge gas is sealed is present between the front surface substrate and the back surface substrate. A plurality of row electrodes extending in the horizontal direction (lateral direction) of each of the display surfaces is formed on the front surface substrate. On the other hand, a plurality of column electrodes extending in the vertical direction (perpendicular direction) of the display surface is formed on the back surface substrate. Pixel cells are formed in the intersection portions (including the discharge spaces) between the row electrodes and the column electrodes. As shown in FIG. 1, the pixel cells are composed of three types: pixel cells P_{R} for emitting red light, pixel cells P_{G} for emitting green light, and pixel cells P_{B} for emitting blue light.

Blackboard surface image data representing the blackboard surface (e.g., uniformly black) to be displayed over the entire screen of the PDP 100 is stored in advance in a blackboard surface image data memory 1. In the blackboard surface image data memory 1, the blackboard surface image data is sequentially read, and the read data is fed as blackboard surface image data D_{BB} to an image overlay circuit 2.

The image overlay circuit 2 generates pixel data PD for expressing, for each of the pixel cells P, an image in which there are superimposed a blackboard surface image expressed by the blackboard surface image data D_{BB}, an image expressed by an external input image data signal D_{IN}, and an image expressed by a trace image data signal D_{TR} (described later), and supplying the data to an SF pixel drive data generator 3 and a drive controller 4. The image overlay circuit 2 supplies the SF pixel drive data generator 3 and the drive controller 4 with the image data PD for expressing, for each of the pixel cells P, an image in which an image expressed by the external input image data signal D_{IN} and an image expressed by the trace image data signal D_{TR} are superimposed in the case that a blackboard display cancel signal is supplied from the drive controller 4 (described later).

The SF pixel drive data generator 3 generates the pixel drive data GD1 to GD8 designed to set each pixel cell P in the subfields SF1 to SF8 (described later) to an on-mode state or an off-mode state in accordance with the brightness level expressed by the pixel data PD for each pixel data PD, and supplies the data to an address driver 5.

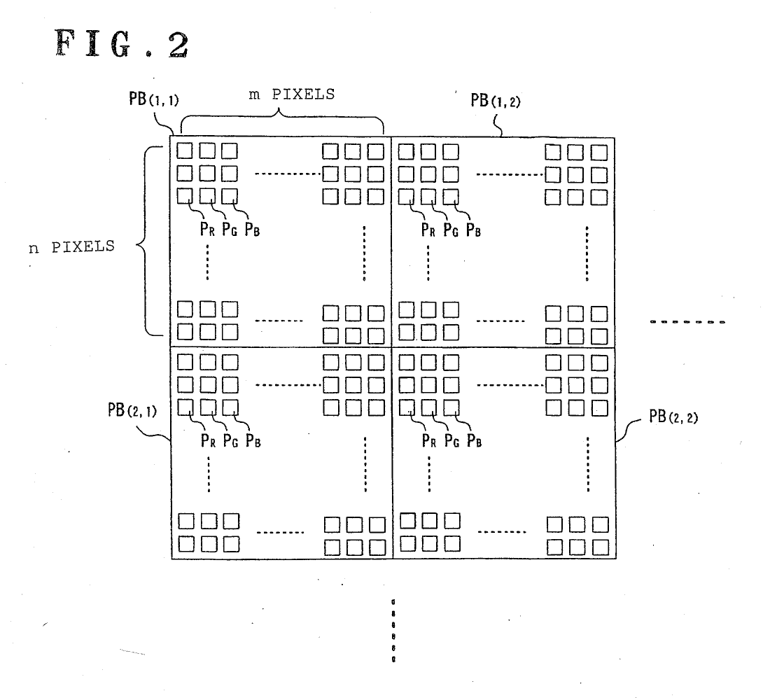

Coordinate data for expressing a coordinate position on the screen of the PDP 100 in which the pixel blocks are positioned is stored in advance in the coordinate data memory 6 for each pixel block composed of a plurality of adjacent pixel cells P. For example, coordinate data for expressing the coordinate position on the screen of the PDP 100 in the pixel blocks PB is associated and stored in the coordinate data memory 6 for each of the pixel blocks PB (the area enclosed by a bold frame) composed of n rows×m columns of pixel cells P as shown in FIG. 2. In the coordinate data memory 6, the coordinate data is read, and the read data is fed to a two-dimensional code converter 7.

The two-dimensional code converter 7 first converts the coordinate data that corresponds to each of the pixel blocks PB to (n×m) bits of two-dimensional code. The two-dimensional code converter 7 then associates the bits of the two-dimensional code with the (n×m) pixel cells P inside the pixel blocks PB, and supplies the bits correlated with each of the pixel cells P to the address driver 5 as pixel drive data GD0 that corresponds to the pixel cells P.

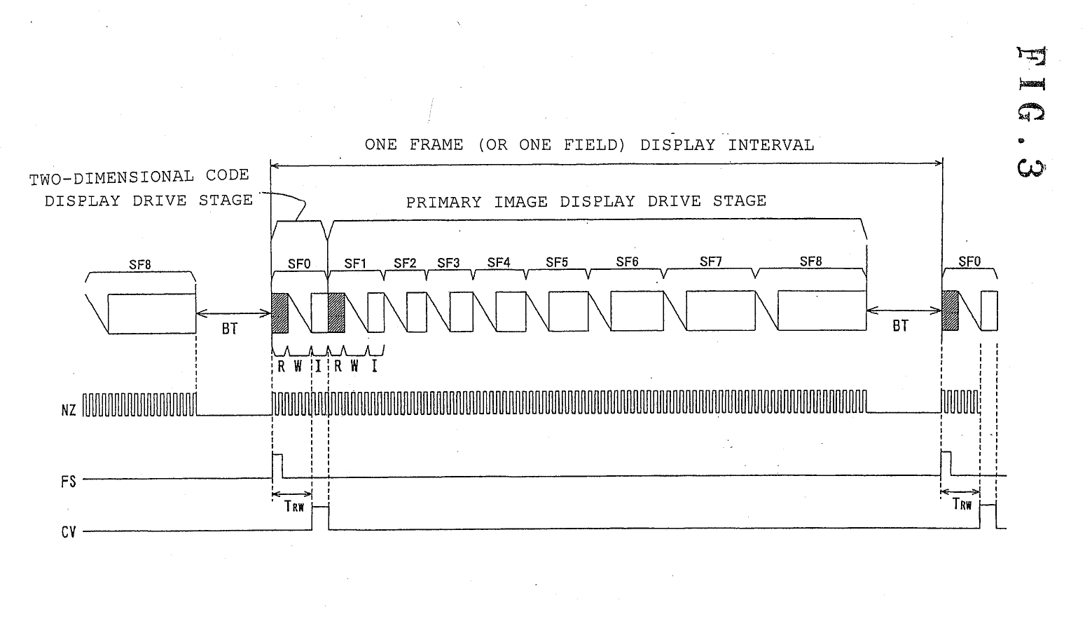

The drive controller 4 sequentially executes a two-dimensional code display drive stage and a primary image display drive stage in the display interval of one frame (or one field) on the basis of the light emission drive sequence in the manner shown in FIG. 3 based on the subfield method. In the primary image display drive stage, the drive controller 4 sequentially executes an addressing stage W and a sustaining stage I in each of the eight subfields SF1 to SF8 in the manner shown in FIG. 3. The drive controller 4 executes a reset stage R prior to the addressing stage W solely for the subfield SF1. Also, for the two-dimensional code display drive stage, the drive controller 4 sequentially executes the reset stage R, the addressing stage W, and the sustaining stage I in the subfield SF0 in the manner shown in FIG. 3. A blanking interval BT having a predetermined interval length is provided after the primary image display drive stage.

The drive controller 4 generates various drive signals for driving the PDP 100 in the manner described below by executing the reset stage R, the addressing stage W, and the sustaining stage I, and feeds the signals to the address driver 5 and a row electrode driver 8.

The row electrode driver 8 applies a reset pulse to all of the row electrodes of the PDP 100 in accordance with the execution of the reset stage R in order to initialize the state of all of the pixel cells P in the PDP 100 to an on-mode state.

Next, in accordance with the execution of the addressing stage W, the address driver 5 generates a pixel data pulse whose voltage corresponds to the pixel drive data GD according to the subfield SF to which the addressing stage W belongs. In other words, the address driver 5, for example, generates a pixel data pulse that corresponds to the pixel driver data GD1 in the addressing stage W of the subfield SF1, and generates a pixel data pulse that corresponds to the pixel driver data GD2 in the addressing stage W of the subfield SF2. At this point, the address driver 5, for example, generates a high-voltage pixel data pulse when pixel drive data GD for indicating that the pixel cell P is to be set in the on-mode state has been supplied, and generates a low-voltage pixel data pulse when pixel drive data GD for indicating an off-mode state setting has been supplied.

In this interval, the row electrode driver 8 sequentially applies a scan pulse to each of the row electrodes of the PDP 100 in synchronization with the application timing of the pixel data pulse groups in increments of one display line. This operation sets each of the pixel cells P for one display line that belongs to the row electrodes to which the scan pulse has been applied to a state (on-mode or off-mode) that corresponds to the pixel data pulse.

Next, in accordance with the execution of the sustaining stage I, the row electrode driver 8 applies a sustain pulse in which only the pixel cells P in an on-mode state are to be repeatedly discharged and made to emit light. The pulse is applied to all of the row electrodes of the PDP 100 during the light emission interval assigned to the subfield SF to which the sustaining stage I belongs. In the embodiment shown in FIG. 3, the shortest light emission interval is assigned to the subfield SF0.

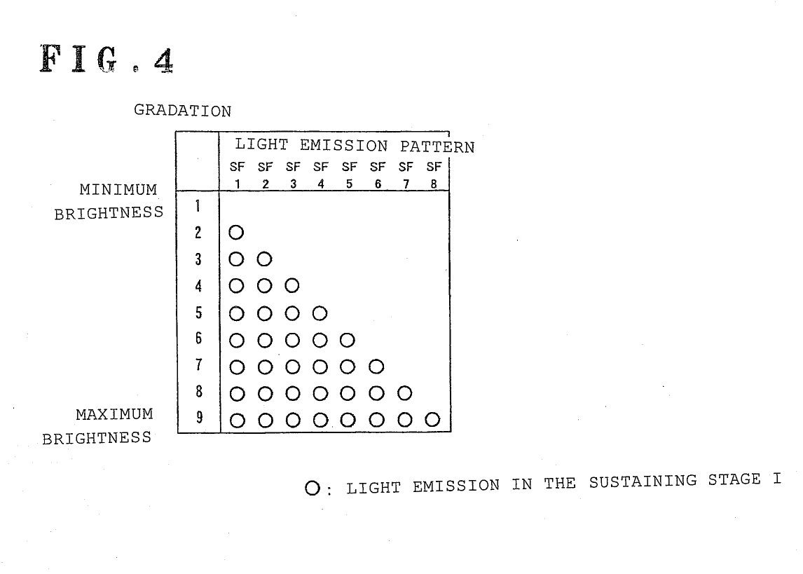

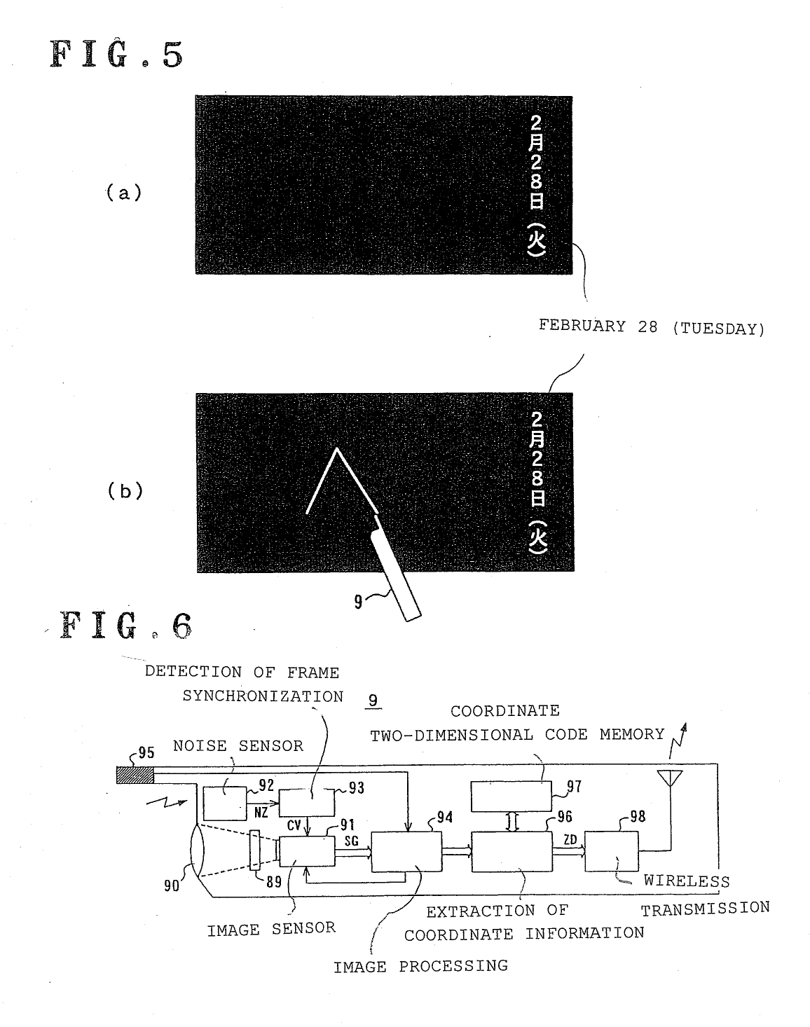

Here, the pixel cells P emit light in the sustaining stage I of each of the subfields SF (indicated by white circles) that continue from the subfield SF1 in the manner shown in FIG. 4 in accordance with the pixel drive data GD1 to GD8 based on the pixel data PD when the primary image display drive stage (subfields SF1 to SF8) is executed in the manner shown in FIG. 3. In other words, light is emitted by the pixel cells P in any one of the nine light emission patterns shown in FIG. 4 in accordance with the brightness level expressed by the pixel data PD. At this point, an intermediate brightness that corresponds to the total light emission interval in one frame display interval is visually perceived. In other words, the brightness level indicated by the pixel data PD is represented in nine gradations in accordance with the nine light emission patterns, as shown in FIG. 4; that is to say, a so-called intermediate brightness having nine gradations is expressed. Therefore, the image representing the blackboard surface as shown, for example, in FIG. 5(a) is displayed on the entire surface of the PDP 100 in accordance with the pixel data PD generated based on the blackboard surface image data D_{BB} for representing the blackboard surface (e.g., uniformly black).

On the other hand, executing the two-dimensional code display drive stage (subfield SF0) causes light to be emitted from each of the pixel cells P in the sustaining stage I of the subfield SF0 in accordance with the pixel drive data GD0 based on the coordinate data, as shown in FIG. 3. In other words, on- and off-patterns based on the two-dimensional information code for representing the coordinate position of each of the pixel blocks PB as shown in FIG. 2 are formed in the coordinate positions of the pixel blocks PB. In FIG. 2, for example, light is emitted in an on- and off-pattern that expresses the first row and first column as the location of each of the (n×m) number of pixel cells P that belong to the pixel block PB_{(1,1)} positioned in the first row and first column within the PDP 100 screen. Also in FIG. 2, light is emitted in an on- and off-pattern that expresses the second row and first column as the location of each of the (n×m) number of pixel cells P that belong to the pixel block PB_{(2,1)} positioned in the second row and first column. The light emission interval assigned to the sustaining stage I of the subfield SF0 in the manner described above is set to an interval that is sufficiently short so that the on- and off-pattern based on the two-dimensional information code cannot be visually perceived.

An electronic chalk 9 according to the present invention extracts the on- and off-pattern based on the two-dimensional information code from the captured image signal obtained by capturing the image on the screen of the PDP 100 in pixel block PB units in the manner shown in FIG. 2, and a coordinate signal for expressing the coordinate position that corresponds to the on- and off-pattern is wirelessly transmitted.

FIG. 6 is a view showing an example of the internal configuration of the electronic chalk 9.

In FIG. 6, an object lens 90 takes in the display light irradiated from the screen of the PDP 100 in area units of the pixel blocks PB, and guides the collected light to an image sensor 91 via an optical filter 89 for cutting off the red and green components. A noise sensor 92 generates a pulse-shaped noise detection signal NZ, which is a logical level 1, upon detection of noise, i.e., a discharge of infrared rays, UV rays, or electromagnetic waves, discharged from the screen of the PDP 100 in accompaniment with an electrical discharge generated in each pixel cell P in the PDP 100; and the signal is fed to the frame synchronization detection circuit 93. In this case, a pulse-shaped noise detection signal NZ, which is a logical level 1, is generated as shown in FIG. 3 each time a discharge occurs. This is because various discharges occur during the interval in which the subfields SF0 to SF8 are executed in the display interval of one frame (or one field). However, since a discharge does not occur in the blanking interval BT after completion of the subfield SF8, the noise detection signal NZ is a logical level 0 during this interval, as shown in FIG. 3. The frame synchronization detection circuit 93 generates an image reception signal CV, which is a logical level 1 during the interval that the sustaining stage I of the subfield SF0 shown in FIG. 3 is being executed and is a logical level 0 during other intervals, and the signal is fed to the image sensor 91.

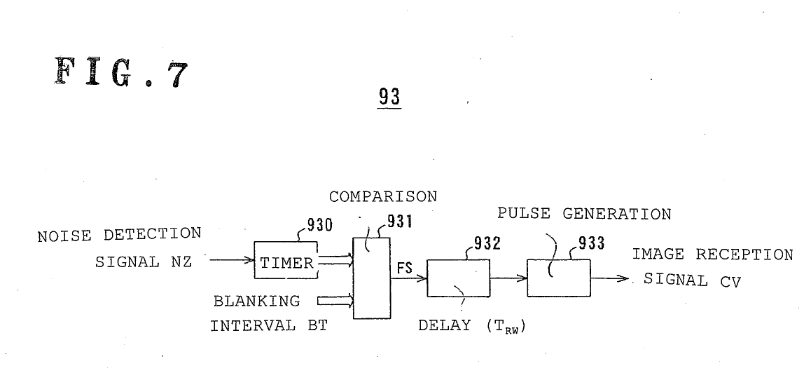

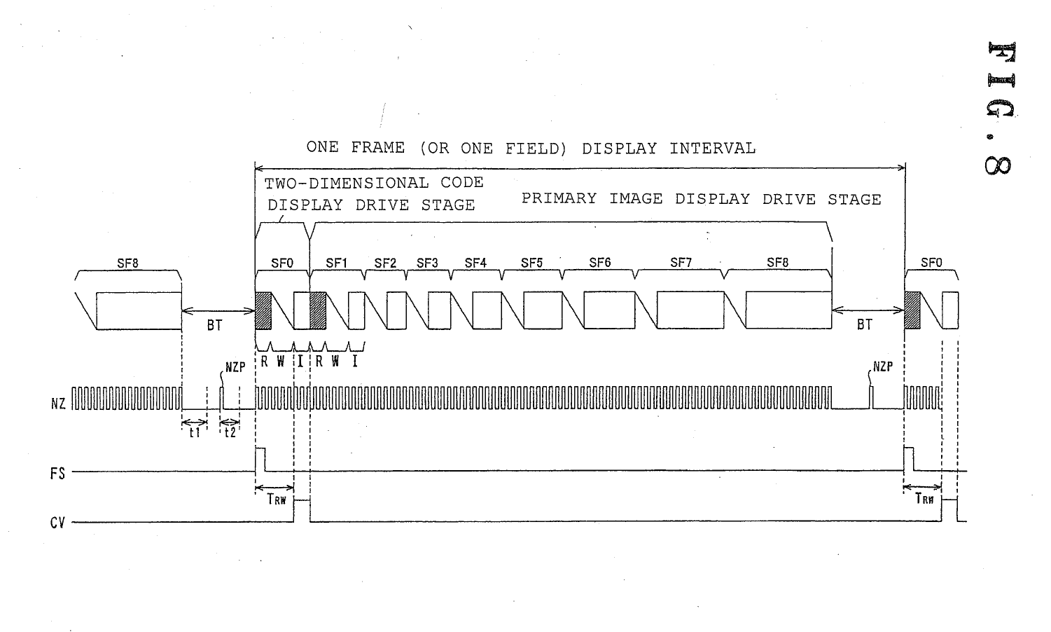

FIG. 7 is a diagram showing an example of the internal configuration of the frame synchronization detection circuit 93.

In FIG. 7, a timer 930 starts from an initial value 0 and counts the number of pulses of a clock signal (not shown) having a predetermined frequency. An elapsed-time signal for indicating the elapsed time that corresponds to the counted value is fed to a comparator 931. The comparator 931 generates a frame synchronization signal FS having a logical level 1 in the manner shown in FIG. 3 when the time indicated by the elapsed-time signal is the same as the blanking interval BT, as shown in FIG. 3, and the signal is sent to a delay circuit 932. The delay circuit 932 delays the frame synchronization signal FS by a time T_{RW} used in the reset stage R and the addressing stage W of the subfield SF0 in the manner shown in FIG. 3, and sends the signal to a pulse generator 933. In accordance with the frame synchronization signal supplied by the delay circuit 932, the pulse generator 933 generates an image reception signal CV having a logical level 1 in the manner shown in FIG. 3 during the time spent on the sustaining stage I of the subfield SF0, and feeds the signal to the image sensor 91.

Here, the image sensor 91 shown in FIG. 6 receives the display light supplied from the object lens 90 only during the interval in which the image reception signal CV having the logical level 1 is fed in the manner shown in FIG. 3, and an image signal that corresponds to the display light is fed to an image processing circuit 94 as a captured image signal SG. In other words, the image sensor 91 supplies an image processing circuit 94 with a captured image signal SG that expresses an on- and off-pattern displayed by the execution of the two-dimensional code display drive stage (subfield SF0), i.e., an on- and off-pattern that corresponds to a two-dimensional information code for indicating the coordinate position of the pixel blocks PB. A writing pressure sensor 95 provided to the distal end of the electronic chalk 9 generates a drawing execution signal for indicating that the blackboard surface is currently being drawn on during the interval in which the distal end of the writing pressure sensor is pressed against the screen of the PDP 100, and feeds the signal to the image processing circuit 94. The image processing circuit 94 receives the captured image signal SG supplied from the image sensor 91 as long as the image execution signal is being supplied, and feeds the signal to a coordinate information extraction circuit 96. The image processing circuit 94 determines that external light is strong when the brightness level indicated by the captured image signal SG is biased toward a brightness level above a predetermined brightness, and an offset signal for suppressing the brightness level is fed to the image sensor 91. In this case, the image sensor 91 adjusts the contrast of the captured image signal SG in accordance with the offset signal. Coordinate data that indicates the coordinate position on the screen of the PDP 100 of each pixel block PB, and two-dimensional code in which the coordinate data has been converted to two-dimensional code in pixel block PB units, are correlated and stored in advance, as shown in FIG. 2. The coordinate information extraction circuit 96 first generates a two-dimensional code that corresponds to the on- and off-pattern inside the pixel blocks PB in pixel block PB units in the manner shown in FIG. 2 on the basis of the captured image signal supplied by the image processing circuit 94. The coordinate information extraction circuit 96 reads from a coordinate two-dimensional code memory 97 the coordinate data that matches the two-dimensional code and corresponds to the two-dimensional code, and feeds the coordinate data to a wireless transmission circuit 98 as coordinate data ZD. The wireless transmission circuit 98 modulates the coordinate data ZD and wirelessly transmits the result.

The receiving circuit 10 shown in FIG. 1 receives a transmission wave from the electronic chalk 9, restores the coordinate data ZD by demodulating the transmission wave, and feeds the result to a trace image data generator 11. The trace image data generator 11 generates image data that expresses straight lines or curved lines, which sequentially trace over each of the coordinate positions shown by the coordinate data ZD sequentially supplied from the receiving circuit 10, and feeds the data to the image overlay circuit 2 as trace image data signal D_{TR}. Driving that follows the primary image display drive stage composed of subfields SF1 to SF8 is thereby carried out in the manner shown in FIG. 3 in accordance with the pixel data PD obtained by superimposing the trace image data signal D_{TR} onto the blackboard surface image data D_{BB}. In this case, the distal end of the electronic chalk 9 is moved while kept in contact with the display screen of the PDP 100, whereupon a straight-line or curved-line image along the movement trajectory is superimposed and displayed on the blackboard surface image shown by the blackboard surface image data D_{BB}, as shown in FIG. 5(b).

In the manner described above, the electronic chalk 9 first detects noise (indicated by NZ in FIG. 3) such as infrared rays, UV rays, or electromagnetic waves irradiated from the screen of the PDP 100. In such a case, an area exists in which noise is interrupted during a predetermined interval (BT) in synchronization with the drive operation of each frame (field), as shown in FIG. 3. In view of the above, the electronic chalk 9 generates a frame synchronization signal (FS) having a logical level 1 when an area is detected in which noise is interrupted during the predetermined interval (BT), and an image reception signal (CV) indicating the execution interval of the sustaining stage I of the subfield SF0 is generated based on the frame synchronization signal. The electronic chalk 9 restores the coordinate position information (ZD) indicated by the two-dimensional code from the captured image signal captured as an image in accordance with the image reception signal (CV), and wirelessly transmits the result.

In this manner, a synchronization signal synchronized with the drive operation of each of the frames executed by the PDP 100 on the basis of the noise irradiated from the screen of the PDP 100 is self-generated in the electronic chalk 9. Therefore, only the information code displayed solely in a predetermined area (SF0) within the display interval of each of the frames (fields) can be read in the electronic chalk 9 in accordance with the synchronization signal self-generated by the electronic chalk, as described above. Therefore, there is no need to provide the display device with the circuit for transmitting the synchronization signal.

In the embodiments described above, operation was described for a case in which the present invention is applied to a PDP in which noise irradiated from the screen is stopped during the blanking interval BT shown in FIG. 3. However, noise NZP may also be generated in the blanking interval BT in the PDP, as shown in FIG. 8. In view of the above, the electronic chalk 9 can operate in the manner described below in relation to such a PDP.

In other words, the frame synchronization detection circuit 93 first detects an area in which noise is interrupted during the first interval t1 in the manner shown in FIG. 8 in accordance with a noise detection signal NZ. In cases in which the continuous interval of noise NZP, initially detected following detection of the area in which noise is interrupted during the first interval t1, is shorter than a second interval t2 in the manner shown in FIG. 8, a frame synchronization signal (FS) having a logical level 1 is generated in accordance with the detection timing of the noise NZP in the manner shown in FIG. 8. In this case, the first interval t1 and the second interval t2 are both shorter than the blanking interval BT, as shown in FIG. 8.

In the electronic blackboard described in the embodiment described above, a plasma display panel (PDP 100) is used as a display device, but no limitation is imposed thereby. In other words, any display can be adopted as long as the display is one in which noise is generated (or stopped) from the display screen in a cycle synchronized with the frame (or field) display interval.

### INDUSTRIAL APPLICABILITY

An ordinary display device in which the reading device is not provided with a circuit for transmitting a synchronization signal can be used in a system adapted to read an information code by capturing an image of the information code displayed on a display.

1. A device for reading an information code in which an information code displayed on a display is read in a predetermined area during each frame display interval, the device for reading an information code having:
noise detection means for detecting noise emitted from said display;
synchronization detection means for generating a synchronization signal synchronized with said frame display interval on the basis of said noise; and
means for restoring said information code from a captured image signal obtained by capturing a display screen of said display as an image in accordance with said synchronization signal.

2. The device for reading an information code of claim 1, wherein
said display is a plasma display panel; and
said noise detection means detects as said noise infrared rays, UV rays, or electromagnetic waves emitted in accompaniment with a discharge that has occurred in said plasma display panel

3. The device for reading an information code of claim 1, wherein
said display is a plasma display panel,
said frame display interval is composed of a blanking interval and an interval in which display driving of said plasma display panel is carried out by a subfield group containing at least one subfield for display driving in said predetermined area; and
said synchronization detection means generates said synchronization signal when an area is detected in which said noise is interrupted during the same interval length as the blanking interval.

4. The device for reading an information code of claim 1, wherein
said display is a plasma display panel,
said frame display interval is composed of a blanking interval and an interval in which display driving of said plasma display panel is carried out by a subfield group containing at least one subfield for display driving in said predetermined area; and
said synchronization detection means generates said synchronization signal with timing that corresponds to detection of initially detected noise in a case in which the continuous interval of noise, initially detected following interruption of said noise during an interval that is shorter than said blanking interval and longer than a predetermined first interval length, is shorter than a predetermined second interval length that is shorter than said blanking interval.

5. A method for reading an information code in which an information code displayed on a display is read in a predetermined area during each frame display interval, the method for reading an information code comprising:
a noise detection step for detecting noise emitted from said display;
a synchronization detection step for generating a synchronization signal synchronized with said frame display interval on the basis of said noise; and
a step for restoring said information code from a captured image signal obtained by capturing a display screen of said display as an image in accordance with said synchronization signal.
